(19) United States
(12) Patent Application Publication
(10) Pub. No.: US 2026/0214528 A1
(43) Pub. Date: Jul. 23, 2026

(54) TERMINAL APPARATUS AND WIRELESS COMMUNICATION SYSTEM

(71) Applicant: KDDI CORPORATION, Tokyo (JP)

(72) Inventors: Jungyeon HONG, Fujimino-shi (JP); Hiroki TAKEDA, Fujimino-shi (JP); Takeo OHSEKI, Fujimino-shi (JP); Issei KANNO, Fujimino-shi (JP); Yanwei LI, Fujimino-shi (JP); Yoshitaka TAKAKU, Fujimino-shi (JP)

(21) Appl. No.: 19/577,825

(22) Filed: Mar. 25, 2026

Related U.S. Application Data
(63) Continuation of application No. PCT/JP2024/033901, filed on Sep. 24, 2024.

(30) Foreign Application Priority Data
Sep. 29, 2023 (JP) 2023-170284

(51) Int. Cl. H04W 36/00

(52) U.S. Cl. CPC H04W 36/00835; H04W 36/0061

(57) ABSTRACT

The present disclosure proposes, in a terminal apparatus that communicates with a plurality of base station apparatuses while switching a connection destination, processing of acquiring a communication parameter associated with at least one handover destination candidate base station apparatus and information on an LTM execution condition, processing of determining whether the LTM execution condition associated with a handover destination candidate base station apparatus is satisfied before receiving a Cell Switch Command instructing a change of a connection destination cell from a handover source base station apparatus, and transmitting an RA preamble to the handover destination candidate base station apparatus associated with the LTM execution condition when the LTM execution condition is satisfied.

### CROSS-REFERENCE TO RELATED APPLICATION(S

This application is a continuation of International Patent Application No. PCT/JP2024/033901 filed on Sep. 24, 2024, which claims priority to and the benefit of Japanese Patent Application No. 2023-170284 filed on Sep. 29, 2023, the entire disclosures of which are incorporated herein by reference.

### BACKGROUND OF THE INVENTION

### Field of the Invention

The present invention relates to a terminal apparatus and a wireless communication system.

### Description of the Related Art

In a mobile communication system, a handover is performed to switch a cell (base station apparatus) to which a terminal apparatus is connected as the terminal apparatus moves. Conventionally, after receiving a handover instruction from a base station apparatus, a terminal apparatus performs processing to establish a connection by executing synchronization establishment and setting processing in a connection switching destination cell. This processing for switching the connection destination takes a certain amount of time, and the terminal apparatus cannot communicate user data during the period in which this processing is being performed.

On the other hand, in the method described in 3GPP (registered trademark) contribution, R2-2209255, a handover source base station apparatus provides communication parameters in a radio resource control (RRC) layer for connection with another base station apparatus, which is a handover destination, to a terminal apparatus before a handover is actually performed. Then, at a timing when the handover should be performed, the handover source base station apparatus transmits a Layer 1 or Layer 2 command instructing the switching of the cell to the terminal apparatus. In response to receiving the command, the terminal apparatus executes a random access procedure with the handover destination base station apparatus, thereby being able to complete the handover without performing subsequent setting processing in the RRC layer. Such a cell switching technology is called LTM (L1L2 Triggered Mobility) and is considered to suppress deterioration of communication efficiency regarding handover.

In the handover processing by LTM disclosed in 3GPP (registered trademark) contribution, R2-2209255, the terminal apparatus needs to receive a Cell Switch command from the base station apparatus.

However, when the Cell Switch Command cannot be received, the terminal apparatus cannot voluntarily initiate the handover processing, and after detecting RLF (Radio Link Failure), must execute cell search processing and reconnection processing. For this reason, in the LTM technology of 3GPP (registered trademark) contribution, R2-2209255, there exists a problem that the instantaneous interruption time of communication cannot be shortened and the handover processing cannot be sped up.

### SUMMARY OF THE INVENTION

In view of such a situation, the present disclosure proposes a technology that enables a terminal apparatus to execute LTM before receiving a Cell Switch command, thereby attempting to speed up handover processing and shorten instantaneous interruption time.

In order to solve the above problem, the present disclosure proposes, as an example, a terminal apparatus that communicates with a plurality of base station apparatuses while switching a connection destination, comprising: a storage device that holds a program regarding handover; and a processor that reads the program from the storage device and executes handover processing, wherein the processor executes: processing of acquiring communication parameters associated with at least one handover destination candidate base station apparatus and information on an LTM execution condition from a connected handover source base station apparatus; processing of determining whether the LTM execution condition associated with a handover destination candidate base station apparatus is satisfied before receiving a Cell Switch Command instructing a change of a connection destination cell from the handover source base station apparatus; and processing of transmitting an RA preamble to the handover destination candidate base station apparatus associated with the LTM execution condition when the LTM execution condition is satisfied.

Further features of the present invention will become apparent from the following description of exemplary embodiments (with reference to the attached drawings). Note that, in the attached drawings, the same reference numerals are given to the same or similar configurations.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a diagram showing a schematic configuration example of a wireless communication system according to the present embodiment.

FIG. 2 is a diagram showing a schematic configuration example of a base station apparatus 100 according to the present embodiment.

FIG. 3 is a diagram showing a schematic configuration example of a terminal apparatus 200 according to the present embodiment.

FIG. 4 is a diagram for explaining a sequence example 1 (in the case of contention-free RA) of handover processing according to the present embodiment.

FIG. 5 is a diagram for explaining a sequence example 2 (in the case of contention-based RA) of handover processing according to the present embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made to an invention that requires a combination of all features described in the embodiments. Two or more of the multiple features described in the embodiments may be combined as appropriate. Furthermore, the same reference numerals are given to the same or similar configurations, and redundant description thereof is omitted.

The present embodiment discloses executing LTM to a candidate cell before a terminal apparatus receives a Cell Switch Command from a handover source base station apparatus. The technology according to the embodiment is not limited to this, but can be applied to, for example, wireless communication in a frequency band FR1 (410 MHz to 7125 MHz).

### Schematic Configuration Example of System

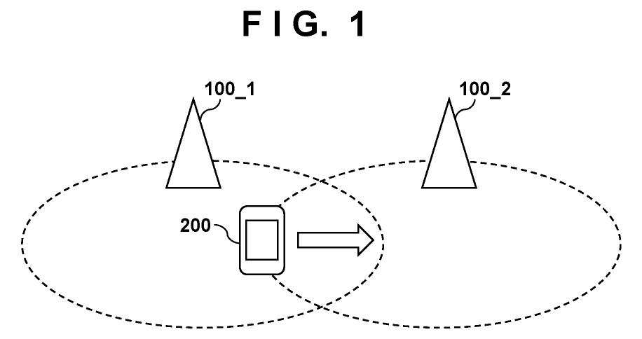

FIG. 1 is a diagram showing a schematic configuration example of a wireless communication system according to the present embodiment. The wireless communication system is a cellular communication system configured according to cellular communication standards such as the 5th Generation (5G) of the 3rd Generation Partnership Project (3GPP (registered trademark)) and its successor standards. The wireless communication system is configured to include a plurality of base station apparatuses (base station apparatus 100_1, base station apparatus 100_2, ...) and a terminal apparatus 200.

In FIG. 1, the terminal apparatus 200 is about to move from within a range of a cell formed by the base station apparatus (handover source base station apparatus) 100_1 into a range of a cell formed by the base station apparatus (handover destination base station apparatus) 100_2. At this time, the terminal apparatus 200 will perform a handover for switching a connection destination base station apparatus from the handover source base station apparatus 100_1 to the handover destination base station apparatus 100_2. Although only the handover destination base station apparatus 100_2 is shown as a handover destination candidate in FIG. 1, actually, a plurality of handover destination candidates (handover destination base station apparatuses 100_3, 100_4, ..., 100_k, ...) may exist.

### Regarding LTM Execution Condition (event)

In the LTM according to the present embodiment, the terminal apparatus 200 starts connection processing and cell switching processing with the handover destination base station apparatus 100_2 and other handover destination candidate base station apparatuses (handover destination base station apparatus 100_k: k=3, 4, ...) without receiving a command (Cell switch command) instructing switching of a cell from the handover source base station apparatus 100_1. As an example, after the terminal apparatus 200 acquires a condition (event) for starting the cell switching processing and information regarding the cell switching processing to be executed when a match with the condition is determined from the handover source base station apparatus 100_1, the terminal apparatus 200 determines a match with the condition and executes the cell switching processing according to the condition. For example, assume that cell switching processing to the handover destination base station apparatus 100_2 is associated with condition 1, and cell switching processing to another handover destination candidate base station apparatus (handover destination base station apparatus 100_3) is associated with condition 2. In this case, when determining (confirming) a match with condition 1, the terminal apparatus 200 executes the cell switching processing to the base station apparatus 100_2. On the other hand, when determining (confirming) a match with condition 2, the terminal apparatus 200 starts the cell switching processing to the other handover destination candidate base station apparatus (handover destination base station apparatus 100_3). A plurality of pieces of information regarding the condition and the cell switching processing are included in an RRC Reconfiguration message of an RRC (Radio Resource Control) layer, and a condition set for each candidate cell is included in condExecutionCond. Further, communication parameters used for communication with the handover destination candidate base station apparatus are included in condLTMReconfig. These pieces of information are provided from the handover source base station apparatus 100_1 to the terminal apparatus 200.

### Specific Example of the Above Condition (event)

As the LTM execution condition (event), for example, it is conceivable to set conditions (CondEventA3, CondEventA4, CondEventA5, CondEventD1, CondEventT1) related to wireless quality of a communicating cell or a candidate cell. In this case, for example, the RRC Reconfiguration includes information such as condExecutionCond=condEventA4 (threshold=threshold 1) and condLTMReconfig=communication parameter to candidate cell 1 in condReconfigId (condition setting identifier)=1, and condExecutionCond=condEventA4 (threshold=threshold 2) and condLTMReconfig=communication parameter to candidate cell 2 in condReconfigId=2, and the information is provided to the terminal apparatus 200.

Further, conventionally, it is conceivable that the base station apparatus 100 sets information (MeasId) for setting event occurrence reporting to the terminal apparatus 200 in condExecutionCond. Here, MeasId is associated with an identifier measObjectId used by the terminal apparatus to specify a wireless quality measurement target, and an identifier reportConfigId used by the terminal apparatus to specify timing of reporting to the base station apparatus. Frequencies of NR and LTE that the terminal apparatus 200 should make measurement targets are associated with the identifier measObjectId. Timing of reporting to the base station apparatus 100, for example, an event of condEventA4 and a threshold related to the event are associated with the identifier reportConfigId. In this way, the terminal apparatus 200 can recognize an event of wireless quality to be determined from MeasId set in condExecutionCond.

### Internal Configuration Example of Base Station Apparatus

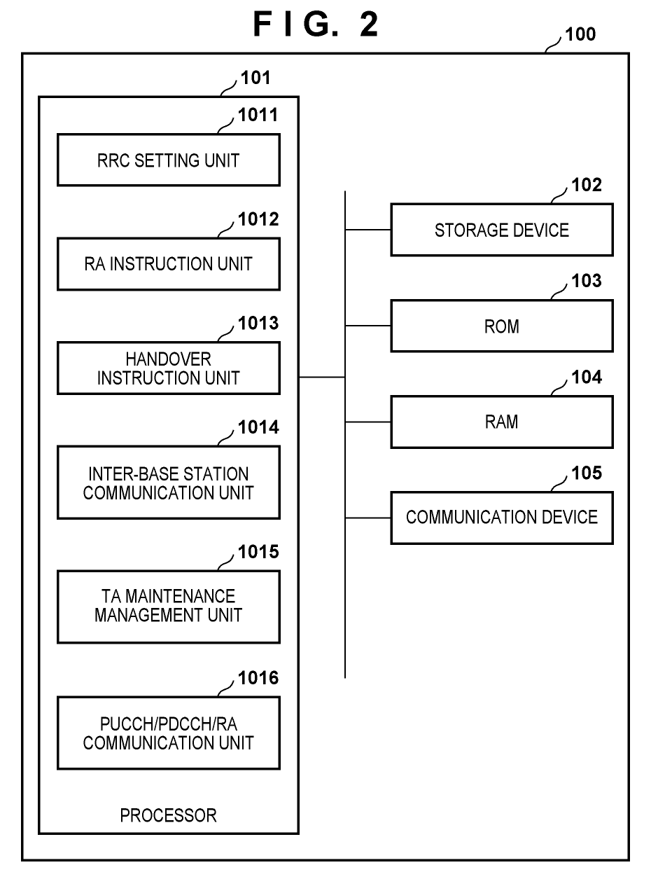

FIG. 2 is a diagram showing a schematic configuration example of the base station apparatus 100. The base station apparatus 100 comprises, for example, a processor 101, a storage device 102, a ROM (Read Only Memory) 103, a RAM (Random Access Memory) 104, and a communication device 105. The processor 101 is a computer configured to include one or more processing circuits such as a general-purpose CPU (Central Processing Unit) and an ASIC (Application Specific Integrated Circuit), and executes the overall processing of the apparatus and each process described above by reading and executing a program stored in the storage device 102 or the ROM 103. The ROM 103 is a read-only memory that stores information such as programs regarding processing executed by the base station apparatus 100 and various parameters. The RAM 104 functions as a workspace when the processor 101 executes a program, and is a random access memory that stores temporary information. The storage device 102 is configured by, for example, a detachable external storage device or the like. The communication device 105 is configured by, for example, a circuit for wireless communication of 5G or its successor standards. Although one communication device 105 is shown in FIG. 2, the base station apparatus 100 may comprise a plurality of communication devices. For example, the base station apparatus 100 has wireless communication devices for 5G and for its successor standards respectively, and an antenna common to those devices. Note that the base station apparatus 100 may separately have an antenna suitable for each standard. Further, the base station apparatus 100 may further have a wired communication device used when communicating with other base station apparatuses or nodes of a core network. The base station apparatus 100 may have a separate communication device 105 for each of a plurality of usable frequency bands, or may have a common communication device 105 for at least a part of those frequency bands.

The processor 101 generates an RRC setting unit 1011, an RA instruction unit 1012, a handover instruction unit 1013, an inter-base station communication unit 1014, a TA maintenance management unit 1015, and a PUCCH/PDCCH/RA communication unit 1016 by reading a program regarding handover stored in the storage device 102 or the ROM 103 and expanding it in an internal memory (not shown).

Each processing unit generated in the processor 101 of FIG. 2 mainly corresponds to a function of the handover source base station apparatus 100_1 to which the terminal apparatus 200 is connected. The handover destination (candidate) base station apparatus 100_2 is similar to the base station apparatus 100_1 except that it does not transmit some signals of the RA procedure and that there are cases where some signals are transmitted to the base station apparatus 100_1, so illustration is omitted here. Further, FIG. 2 shows only functions particularly related to the present embodiment, and illustration of other various functions that the base station apparatus 100 can have is omitted. For example, the base station apparatus 100 naturally has other functions generally possessed by base station apparatuses compliant with 5G and its successor standards. Further, the functional blocks in FIG. 2 are shown schematically, and respective functional blocks may be realized by being integrated, or may be further subdivided. Further, each function in FIG. 2 may be realized by, for example, the processor 101 executing a program stored in the ROM 103 or the storage device 102, or may be realized by, for example, a processor existing inside the communication device 105 executing predetermined software. Note that details of processing executed by each functional unit described above will not be explained here, and only rough functions thereof will be outlined.

The RRC setting unit 1011 of the handover source base station apparatus 100_1 performs setting of the RRC layer for the connected terminal apparatus 200, for example. The RRC setting unit 1011 transmits a handover request to another base station apparatus 100 (handover destination base station apparatus 100_2, handover destination base station apparatus 100_3, etc.) that is a candidate for a handover destination providing an adjacent cell, acquires communication setting information (communication parameters) therefrom, and notifies the terminal apparatus 200 of the communication setting information and the LTM execution condition (communication parameters of each candidate cell and LTM execution condition) by a message of the RRC layer. Further, in this case, the aforementioned communication setting information (communication parameters) also includes information required when the terminal apparatus 200 executes a random access procedure (a sequence for RA preamble generation, information on wireless resources used for RA preamble transmission, etc.). In the present embodiment, an RRC layer message is an RRC Configuration message. Then, the RRC setting unit 1011 performs connection processing setting between the terminal apparatus 200 and the other base station apparatus 100 (handover destination base station apparatus 100_2) upon receiving an RRC Configuration Complete message from the terminal apparatus 200.

The RA instruction unit 1012 instructs the terminal apparatus 200 for which the setting of the RRC layer has been completed to transmit an RA preamble to the other base station apparatus 100 (handover destination base station apparatus 100_2) that is a candidate for the handover destination. Here, the RA preamble transmission instruction includes a sequence for RA preamble generation unique to the terminal apparatus 200 or a group of sequences usable also by other terminal apparatuses 200 trying to connect to the other base station apparatus 100, and also includes information on wireless resources used for transmission of the RA preamble. The RA instruction unit 1012 can instruct the connected terminal apparatus 200 to transmit the RA preamble to the handover destination base station apparatus 100_2 (candidate 1) by, for example, a Physical Downlink Control Channel (PDCCH) order. Further, the RA instruction unit 1012 instructs the terminal apparatus 200 to retransmit the RA preamble as necessary, or, when configured so that the RA preamble is repeatedly transmitted, can transmit a RA preamble transmission stop instruction to the terminal apparatus 200.

The handover instruction unit 1013 of the handover source base station apparatus 100_1 gives an instruction for causing the terminal apparatus 200 to execute a handover. The handover instruction unit 1013 transmits, for example, a Cell switch command including information such as a cell identifier capable of specifying the handover destination base station apparatus 100_2 to the terminal apparatus 200. Note that when a TA (Timing Advance) value used for uplink communication is determined by transmission of the RA preamble by the terminal apparatus or the like, the TA value can be included in the command transmitted to the terminal apparatus 200. According to this, the terminal apparatus 200 becomes able to transmit an uplink user data signal using the TA value immediately after the handover.

The inter-base station communication unit 1014 of the base station apparatus 100_1 performs communication with each handover destination candidate base station apparatus (handover destination base station apparatus 100_2, 100_3, etc.) (for example, communication by a dedicated wired line). The inter-base station communication unit 1014 can notify, for example, the handover destination base station apparatus 100_2, which is a transmission destination of the RA preamble, that it causes the connected terminal apparatus 200 to transmit the RA preamble. Further, the inter-base station communication unit 1014 is used, for example, to receive information for the RA procedure in the handover destination candidate base station apparatus (handover destination base station apparatus 100_2). Further, the inter-base station communication unit 1014 can receive, for example, a message (message 2 or message 4) to be transmitted from the handover destination base station apparatus 100_2 to the terminal apparatus 200 in the RA procedure. Furthermore, the handover source base station 100_1 can acquire the TA value calculated in the handover destination base station apparatus 100_2 via the inter-base station communication unit 1014. Note that the signal received in the inter-base station communication unit 1014 is transferred to the terminal apparatus 200 via, for example, the RA instruction unit 1012.

The TA maintenance management unit 1015 of the handover source base station 100_1 manages a TA value that should be used when the terminal apparatus 200 transmits an uplink signal to the handover destination base station apparatus 100_2. The TA maintenance management unit 1015 sets, for example, an expiration date or an update cycle of the TA value, and can instruct the terminal apparatus 200 to retransmit the RA preamble, for example, so that the TA value is updated when the expiration date expires or when the update cycle arrives. Further, the TA maintenance management unit 1015 may notify the terminal apparatus 200 of SRS setting in the handover destination base station apparatus 100_2 and cause the terminal apparatus 200 to transmit SRS using the SRS setting, thereby causing the TA value to be updated. Note that the terminal apparatus 200 may acquire the TA value via the TA maintenance management unit 1015 of the handover destination base station apparatus 100_2. In this case, the base station apparatus 100_2 can transmit a RA preamble transmission instruction or an SRS transmission instruction to the terminal apparatus 200.

The PUCCH/PDCCH/RA communication unit 1016 will operate, for example, when the base station apparatus 100 becomes the handover destination base station apparatus 100_2. As described above, when the handover destination base station apparatus 100_2 notifies the handover source base station apparatus 100_1 of the communication setting information (communication parameters), the handover destination base station apparatus 100_2 can start reception of PUCCH, transmission of PDCCH, and reception of the RA preamble with the terminal apparatus 200. For example, as described above, the PUCCH/PDCCH/RA communication unit 1016 receives an RA preamble from the terminal apparatus 200 or transmits an RA response to the terminal apparatus 200 in order to execute an RA (Random Access) procedure when executing (continuing) a conditional handover.

### Internal Configuration Example of Terminal Apparatus

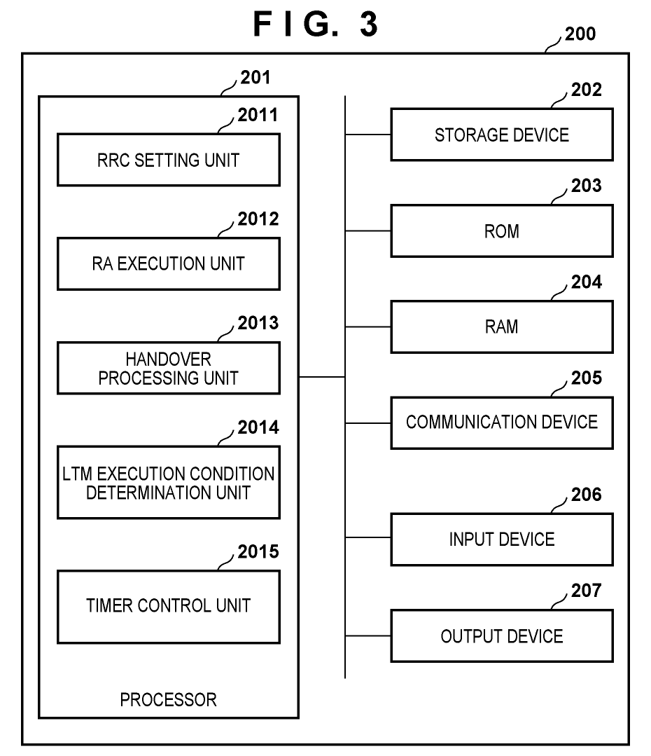

FIG. 3 is a diagram showing a schematic configuration example of the terminal apparatus 200. The terminal apparatus 200 comprises, for example, a processor 201, a storage device 202, a ROM (Read Only Memory) 203, a RAM (Random Access Memory) 204, a communication device 205, an input device 206, and an output device 207. The processor 201 is a computer configured to include one or more processing circuits such as a general-purpose CPU (Central Processing Unit) and an ASIC (Application Specific Integrated Circuit), and executes the overall processing of the apparatus and each process described above by reading and executing a program stored in the storage device 202 or the ROM 203. The ROM 203 is a read-only memory that stores information such as programs regarding processing executed by the terminal apparatus 200 and various parameters. The RAM 204 functions as a workspace when the processor 201 executes a program, and is a random access memory that stores temporary information. The storage device 202 is configured by, for example, a detachable external storage device or the like. The communication device 205 is configured by, for example, a circuit for wireless communication of 5G or its successor standards. Although one communication device 205 is shown in FIG. 3, the terminal apparatus 200 may comprise a plurality of communication devices. For example, the terminal apparatus 200 has wireless communication devices for 5G and for its successor standards respectively, and an antenna common to those devices. Also, the terminal apparatus 200 may have a communication device compliant with wireless communication standards other than cellular communication standards, such as a wireless local area network (LAN) or Bluetooth (registered trademark). Furthermore, the terminal apparatus 200 may separately have an antenna suitable for each standard. Further, the terminal apparatus 200 may have a separate communication device 205 for each of a plurality of usable frequency bands, or may have a common communication device 205 for at least a part of those frequency bands.

The input device 206 can be configured by, for example, a touch panel or a numeric keypad, and is used when a user performs a predetermined operation or inputs desired information. The output device 207 can be configured by, for example, a display device, and displays information indicating a communication status, information indicating success or failure of a handover, etc. in relation to the present embodiment.

The processor 201 generates an RRC setting unit 2011, an RA (Random Access) execution unit 2012, an LTM execution condition determination unit 2014, a handover processing unit 2013, and a timer control unit 2015 by reading a program regarding handover stored in the storage device 202 or the ROM 203 and expanding it in an internal memory (not shown). Note that FIG. 3 shows only functions particularly related to the present embodiment, and illustration of other various functions that the terminal apparatus 200 can have is omitted. For example, the terminal apparatus 200 naturally has other functions generally possessed by terminal apparatuses compliant with 5G and its successor standards. Further, the functional blocks in FIG. 3 are shown schematically, and respective functional blocks may be realized by being integrated, or may be further subdivided.

The RRC setting unit 2011 performs connection setting processing with the handover destination base station apparatus (candidate 1) 100_2 by receiving an RRC layer message from the connected handover source base station apparatus 100_1. Note that the RRC setting unit 2011 will hold settings of the connected handover source base station apparatus 100_1 and settings of a plurality of handover destination candidate base station apparatuses (handover destination base station apparatus 100_k: k=2, 3, 4, ..., n) in parallel.

The RA execution unit 2012 receives an RA preamble transmission instruction from the handover source base station apparatus 100_1. The RA preamble transmission instruction is performed via a PDCCH order. Note that the RA execution unit 2012 can also receive, for example, an RA preamble retransmission instruction, an RA preamble transmission stop instruction, and the like. Further, in response to the reception of the RA preamble transmission instruction, the RA execution unit 2012 transmits the RA preamble to the handover destination (candidate 1) base station apparatus 100_2. Here, the sequence for the generation of the RA preamble and information on wireless resources for reception of the RA preamble in the handover destination base station apparatus (candidate 1) 100_2 are acquired from the connected handover source base station apparatus 100_1. Note that the information on the sequence and wireless resources may be acquired from system information being sent out by the handover destination base station apparatus 100_2.

The handover processing unit 2013 changes the connection destination to the handover destination base station apparatus (candidate 1) 100_2 in response to the reception of a Cell switch command from the connected handover source base station apparatus 100_1. When allocation of an uplink wireless resource in the handover destination base station apparatus 100_2 is notified in the received Cell Switch command, the terminal apparatus 200 can immediately transmit an uplink signal using the wireless resource.

On the other hand, the handover processing unit 2013 instructs the LTM execution condition determination unit 2014 to judge whether it is in a state matching the above LTM execution condition. That is, the LTM execution condition determination unit 2014 determines whether the LTM execution conditions associated with the plurality of candidate cells notified from the handover source base station apparatus 100_1 are satisfied. A destination of a handover to be executed is uniquely determined by a condition match. For example, the LTM execution condition is decided such that a threshold included in the communication parameters is set low for a candidate cell with good communication status (not congested), and a threshold is set high for a candidate cell with poor communication status (congested).

When the match of the above LTM execution condition is determined (confirmed) by the LTM execution condition determination unit 2014, the handover processing unit 2013 executes handover processing including RA execution processing for the candidate cell (handover destination base station apparatus 100_k) satisfying the condition (details will be described later). For example, when it is determined that the LTM execution condition associated with the handover destination base station apparatus 100_2 which is candidate 1 is satisfied, even when the above Cell Switch Command cannot be received, the handover processing unit 2013 can voluntarily execute the handover processing in the same manner as when it could be received. For this reason, it is not necessary to execute reconnection processing starting from cell search, and it becomes possible to perform cell switching rapidly.

The timer control unit 2015 controls start and stop of various timers (T304, etc.) described later. For example, the timer (T304) starts upon the trigger of confirming the above LTM execution condition match and determining LTM execution, and stops when UE Contention Resolution Identity MAC CE or C-RNTI addressed DCCH is received from the connection destination base station apparatus 100.

### Operation at the Time of RLF Detection

As described above, regarding the LTM execution condition designated from the handover source base station apparatus 100_1, when the terminal apparatus 200 determines (confirms) the condition match, it starts the cell switching processing. On the other hand, when detecting RLF (Radio Link Failure), the terminal apparatus 200 may start the cell switching processing even if the condition is not matched.

When providing the LTM execution condition and the information (communication parameters) regarding the cell switching processing associated with the condition for each candidate cell to the terminal apparatus 200, the handover source base station apparatus 100_1 also provides information of attemptCondReconfig=True/False. When detecting RLF (Radio Link Failure), the terminal apparatus 200 searches for and selects a cell to be used for communication. When attemptCondReconfig notified together with the information regarding the cell switching processing is True, the terminal apparatus 200 determines whether the cell selected after the search is a base station apparatus of a handover destination candidate designated in the cell switching processing (handover destination base station apparatus 100_k). When determining that it is not a handover destination base station apparatus designated in the cell switching processing, the terminal apparatus 200 executes reconnection processing as conventionally. When it is a handover destination base station apparatus (any of the notified candidate cells) designated in the cell switching processing, the cell switching processing is started even if the condition is not matched. Thereby, the instantaneous interruption time can be shortened.

### Handover Processing Sequence Example (in the case of contention-free RA)

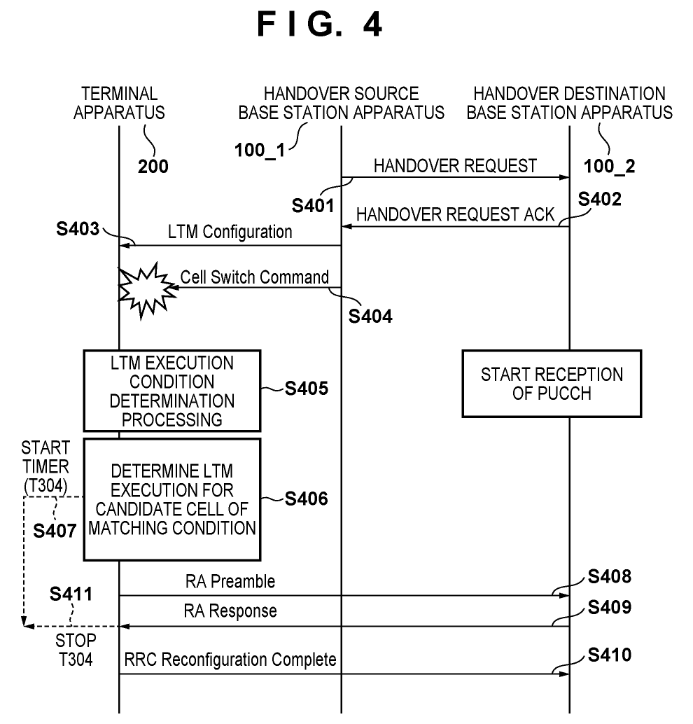

FIG. 4 is a diagram for explaining an example of a sequence (in the case of contention-free RA) of handover processing executed upon matching the LTM execution condition without receiving the Cell Switch Command according to the present embodiment. The sequence shown in FIG. 4 is an example, and modifications as described above can be performed in each procedure. For example, FIG. 4 shows an example in which a unique sequence is notified to the terminal apparatus 200 as a sequence for generation of an RA preamble to be transmitted to the handover destination base station apparatus 100_2, but it may be replaced with the above-described procedure in which a group of sequences available to a plurality of terminal apparatuses 200 is notified. In the example of FIG. 4, it is assumed that a connection is established between the handover source base station apparatus 100_1 and the terminal apparatus 200. In each step, each processing unit (RRC setting unit 1011, etc.) is the operation subject, but since each processing unit is a function realized by the processor 101 or 201 of the base station apparatus 100 or the terminal apparatus 200, the processor 101 or 201 may be the operation subject. In the following description, each processing unit of the handover source base station apparatus 100_1 is denoted as RRC setting unit 1011_1, RA instruction unit 1012_1, handover instruction unit 1013_1, inter-base station communication unit 1014_1, TA maintenance management unit 1015_1, and PUCCH/PDCCH/RA communication unit 1016_1. Also, each processing unit of the handover destination base station apparatus 100_2 is denoted as RRC setting unit 1011_2, RA instruction unit 1012_2, handover instruction unit 1013_2, inter-base station communication unit 1014_2, TA maintenance management unit 1015_2, and PUCCH/PDCCH/RA communication unit 1016_2. Furthermore, in each step below, various communications are actually executed by each processing unit of the base station apparatus and the terminal apparatus controlling the communication device 105 and the communication device 205.

### (i) Step S401

The inter-base station communication unit 1014_1 of the handover source base station apparatus 100_1 transmits a HANDOVER REQUEST message to the inter-base station communication unit 1014_2 of the handover destination base station apparatus 100_2 forming an adjacent cell, which is a handover destination candidate for the terminal apparatus 200, or other base station apparatuses (other candidate cells: inter-base station communication unit 1014_k (k=3, 4, ...) of handover destination base station apparatus 100_k).

### (ii) Step S402

When receiving the HANDOVER REQUEST message, the inter-base station communication unit 1014_2 of the handover destination (candidate 1) base station apparatus 100_2 returns a HANDOVER REQUEST ACK message including information on communication parameters to be used when the terminal apparatus 200 connects, etc., to the handover source base station apparatus 100_1. The communication parameters include CG (Configured Grant) setting information including information such as setting of beams, parameters when executing an RA (Random Access) procedure, and wireless resources (frequency and time resources) to be used in the handover destination base station apparatus 100_2. Other candidate cell base station apparatuses similarly provide communication parameters to the handover source base station apparatus 100_1.

### (iii) Step S403

The RRC setting unit 1011_1 of the handover source base station apparatus 100_1 notifies the terminal apparatus 200 of an LTM Configuration message including the communication parameters etc. acquired from the handover destination base station apparatus 100_2. At this time, the RRC setting unit 1011_1 also provides a condition (event: LTM execution condition) enabling execution of LTM before the terminal apparatus 200 receives a Cell Switch Command to the terminal apparatus 200. By this processing, the terminal apparatus 200 does not need to perform RRC layer setting processing after the handover to the handover destination base station apparatus 100_2 is instructed from the RA instruction unit 1012_1. Although FIG. 4 shows a case where there is only one handover destination base station apparatus, when a plurality of handover destination (candidate) base station apparatuses exist, similar setting processing is executed for each.

The RRC setting unit 2011 of the terminal apparatus 200 receives information associating, for example, an instruction to measure a synchronization signal (SS)/physical broadcast channel (PBCH) block (SSB: Synchronization Signal Block) transmitted from the handover destination base station apparatus 100_2, an SSB index, CG (Configured grant) setting information regarding uplink resources, and uplink beam information, by the LTM Configuration message. The terminal apparatus 200 uses the first CG setting information and beam information if SSB index=1, and uses the second CG setting information and beam information if SSB index=2.

For example, when measuring a wireless signal (e.g., SSB) transmitted from the handover destination base station apparatus 100_2, the handover processing unit 2013 of the terminal apparatus 200 notifies the handover source base station apparatus 100_1 of the measurement result of the SSB. Here, the inter-base station communication unit 1014_1 of the handover source base station apparatus 100_1 may notify the inter-base station communication unit 1014_2 of the handover destination base station apparatus 100_2 of this measurement result. In this case, the handover destination base station apparatus 100_2 can specify an approximate beam to be used for communication with the terminal apparatus 200. Note that the handover instruction unit 1013 of the handover destination base station apparatus 100_2 may transmit CSI-RS and cause the terminal apparatus 200 to measure it for formation of an even finer beam. In this case, the inter-base station communication unit 1014_1 of the handover destination base station apparatus 100_2 transmits CSI-RS setting information to the handover source base station apparatus 100_1. The handover instruction unit 1013_2 of the handover source base station apparatus 100_1 can transfer the setting information to the terminal apparatus 200. The terminal apparatus 200 may measure CSI-RS based on the setting information and report the measurement result to the connected handover source base station apparatus 100_1. Then, the inter-base station communication unit 1014_1 of the handover source base station apparatus 100_1 transfers the measurement result to the handover destination base station apparatus 100_2. Thereby, the handover instruction unit 1013_2 of the handover destination base station apparatus 100_2 becomes able to transmit a downlink signal using a fine beam immediately after the terminal apparatus 200 hands over to the handover destination base station apparatus 100_2.

Note that when RLF (Radio Link Failure) occurs, the terminal apparatus 200 measures the SSB of the candidate cell (handover destination base station apparatus 100_2) and determines whether it is in a connectable state. When determining that connection is possible, the terminal apparatus 200 can specify a wireless resource used for uplink transmission and an uplink beam from the SSB index using the information received in the LTM Configuration, and start communication.

### (iv) Step S404

The handover instruction unit 1013_1 of the handover source base station apparatus 100_1 transmits a Cell Switch Command including the TA value of the handover destination base station apparatus 100_2 to the terminal apparatus 200. The Cell Switch Command can be transmitted using, for example, a medium access control control element (MAC CE) or downlink control information (DCI).

When the handover processing unit 2013 of the terminal apparatus 200 receives the Cell Switch Command, a resource for PUSCH is allocated by the handover destination base station apparatus 100_2. Then, the terminal apparatus 200 becomes able to transmit user data to the handover destination base station apparatus 100_2 using the allocated resource for PUSCH. Note that the terminal apparatus 200 has already executed the RA procedure as described above. For this reason, when the terminal apparatus 200 has received the Cell Switch Command, it is not necessary to execute the RA procedure again, and the user data can be immediately transmitted to the handover destination base station apparatus 100_2 using the designated wireless resource.

Also, when the Cell Switch Command can be received, the handover processing unit 2013 of the terminal apparatus 200 may transmit an acknowledgment (Ack) or the like to the handover source base station apparatus 100_1. Furthermore, when receiving the Cell Switch Command, the handover processing unit 2013 switches the connection destination to the handover destination base station apparatus 100_2, and may transmit Ack, RRCReconfigurationComplete, or the like to the handover destination base station apparatus 100_2 using the allocated uplink wireless resource. Then, the inter-base station communication unit 1014 of the handover destination base station apparatus 100_2 can transfer the acknowledgment to the handover source base station apparatus 100_1. Thereby, the handover source base station apparatus 100_1 can recognize that the terminal apparatus 200 has switched the connection destination to the handover destination base station apparatus 100_2, and can discard the context information of the terminal apparatus 200, for example.

### (v) Step S405

The LTM execution condition determination unit 2014 of the terminal apparatus 200 determines (confirms) the presence or absence of a match (satisfaction) of the above LTM execution condition. Specifically, the LTM execution condition determination unit 3014 determines whether the LTM execution condition corresponding to each candidate cell notified from the handover source base station apparatus 100_1 is satisfied.

### (vi) Step S406

When the LTM execution condition determination unit 2014 of the terminal apparatus 200 confirms a match of the LTM execution condition, the handover processing unit 2013 determines execution of processing for cell switching to the handover destination base station apparatus 100_k of the candidate cell corresponding to the condition match. Note that when there are a plurality of candidate cells for which the LTM execution condition matches, for example, a candidate cell for which the distance between the terminal apparatus 200 and the respective handover destination base station apparatus 100_k is the shortest may be selected as a switching destination, or a candidate cell with the lowest congestion degree may be selected as a switching destination.

### (vii) Step S407

When a match of the LTM execution condition is confirmed, the timer control unit 2015 of the terminal apparatus 200 starts a timer (T304).

### (viii) Step S408

The RA execution unit 2012 of the terminal apparatus 200 transmits an RA preamble to the handover destination base station apparatus (for example, handover destination base station apparatus 100_2) designated in the cell switching processing associated with the condition.

### (ix) Step S409

When receiving the RA preamble transmitted from the terminal apparatus 200 by PUCCH, the PUCCH/PDCCH communication unit 1016_2 of the handover destination base station apparatus 100_2 transmits an RA response (UL grant) to the terminal apparatus 200 by PDCCH, and notifies the TA value of the handover destination base station apparatus 100_2 and information on wireless resources to be used for uplink transmission.

### (x) Step S410

The handover processing unit 2013 of the terminal apparatus 200 transmits RRCReconfigurationComplete to the handover destination base station apparatus 100_2 at the transmission timing of the instructed PUSCH (Physical Uplink Shared Channel).

### (xi) Step S411

When the Random Access procedure succeeds, the timer control unit 2015 of the terminal apparatus 200 stops the timer (T304) started in Step S407. However, the timer stop operation upon success of the Random Access procedure differs depending on whether it is the case of contention-free or the case of contention-based.

In the case of CFRA (contention-free), the MAC that received the Random Access Response notifies the RRC of successful completion of the Random Access procedure. When the RRC processing unit in the terminal apparatus receives successful completion of the Random Access procedure from the MAC processing unit in the terminal apparatus, the timer control unit 2015 determines that the cell switching processing is successful and stops T304.

Note that after cell switching, the terminal apparatus 200 may hold the information condLTMReconfig regarding the cell switching processing. By the terminal apparatus 200 holding the information regarding the cell switching processing even after cell switching, it is possible to make it unnecessary to newly receive condLTMReconfig from the base station apparatus after cell switching. Further, information regarding whether or not to hold the information condLTMReconfig regarding the cell switching processing may be notified from the handover source base station apparatus 100_1 before cell switching to the terminal apparatus 200. As an example, it is possible to notify to hold only information regarding cell switching processing that was not executed and to delete information regarding cell switching processing that was executed.

As described above, it is possible to shorten the period (instantaneous interruption time) during which user data communication cannot be performed when the terminal apparatus 200 hands over from the handover source base station apparatus 100_1 to the handover destination base station apparatus 100_2. Thereby, for example, it becomes possible to provide communication services requiring low delay and high reliability. Further, by shortening the period (instantaneous interruption time) during which user data communication cannot be performed, it becomes possible to suppress a decrease in efficiency of wireless communication.

### Handover Processing Sequence Example (in the case of contention-based RA)

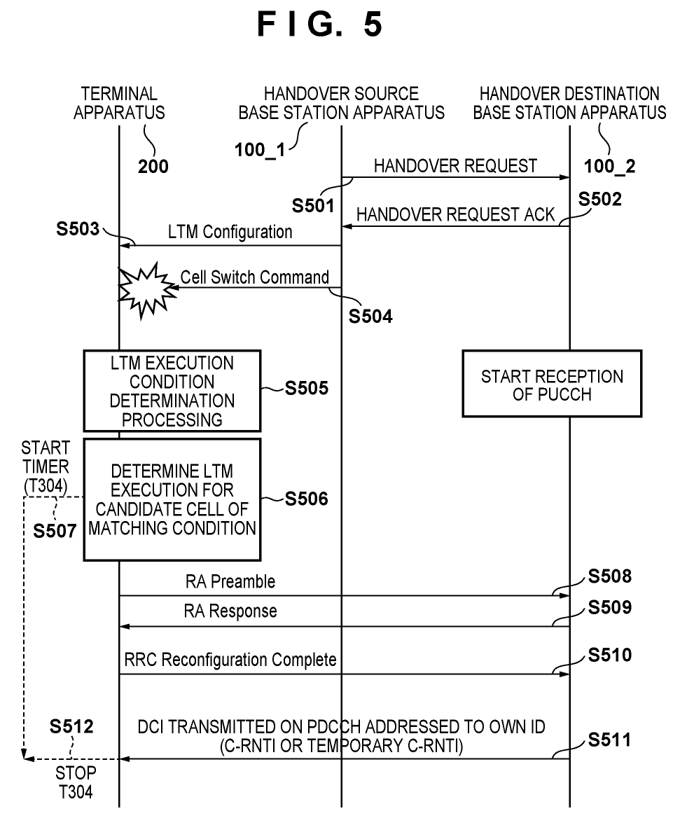

FIG. 5 is a diagram for explaining a sequence (in the case of contention-based RA) of handover processing executed by matching the LTM execution condition without receiving the Cell Switch Command according to the present embodiment.

### (i) Step S501 to Step S510

This is the same processing as Step S401 to Step S410 in FIG. 4.

### (ii) Step S511

In the case of CBRA (contention-based), the handover processing unit 2013 of the terminal apparatus 200 transmits its own ID (C-RNTI or Temporary C-RNTI) to the handover destination base station apparatus 100_2. Thereafter, when receiving DCI transmitted on the PDCCH addressed to its own ID (C-RNTI or Temporary C-RNTI) from the handover destination base station apparatus 100_2, the handover processing unit 2013 determines that Contention Resolution is successful. When determining that Contention Resolution is successful, the MAC processing unit in the terminal apparatus 200 notifies the RRC processing unit in the terminal apparatus 200 of successful completion of the Random Access procedure. When the RRC processing unit in the terminal apparatus 200 receives successful completion of the Random Access procedure from the MAC processing unit in the terminal apparatus, it is determined that the cell switching processing is successful, and the timer control unit 2015 stops the timer (T304).

### Summary of Embodiment

(i) The terminal apparatus 200 acquires communication parameters associated with the handover destination base station apparatus (handover destination candidate base station apparatus) 100_k (k=2, 3, 4, ... n) and information on the LTM execution condition from the handover source base station apparatus 100_1. Then, the handover source base station apparatus 100_1 transmits a Cell Switch Command instructing a change of the connection destination cell to the terminal apparatus 200. Before receiving the Cell Switch Command, the terminal apparatus 200 determines whether the LTM execution condition associated with the handover destination base station apparatus 100_2 is satisfied. When the LTM execution condition is satisfied, the terminal apparatus 200 transmits an RA preamble to the handover destination base station apparatus 100_2 associated with the LTM execution condition. In this way, since the handover processing is resumed without waiting for the detection of RLF, the handover processing can be sped up and the instantaneous interruption time can be shortened.

The information on the LTM execution condition provided to the terminal apparatus 200 together with the communication parameters from the handover source base station apparatus 100_1 includes CondEventA3, CondEventA4, CondEventA5, CondEventD1, and CondEventT1 defined in the 3GPP standards. Thereby, the LTM according to the present embodiment can be realized by utilizing the current 3GPP standards.

(ii) Further, when the terminal apparatus 200 detects a Radio Link Failure (RLF), even if the satisfaction of the LTM execution condition cannot be confirmed, if it is confirmed that the destination cell of the cell switching by LTM execution has the minimum wireless quality usable for communication (for example, when the cell of the cell switching destination satisfies cell selection criterion S), the terminal apparatus 200 determines to execute LTM and executes processing of transmitting an RA preamble to the corresponding handover destination base station apparatus 100_k. On the other hand, when the terminal apparatus 200 detects a Radio Link Failure (RLF) and it cannot be confirmed that the cell of the destination of cell switching by LTM execution has the minimum wireless quality usable for communication, it executes reconnection processing starting from cell search. In this way, even when RLF occurs, execution of reconnection processing can be avoided by using the LTM execution setting, and speeding up of handover processing and shortening of instantaneous interruption time can be realized.

(iii) The functions of the present embodiment and each example can also be realized by software program code. In this case, a storage medium recording the program code is provided to a system or an apparatus, and a computer (or CPU or MPU) of the system or the apparatus reads out the program code stored in the storage medium. In this case, the program code itself read out from the storage medium realizes the functions of the above-described embodiment, and the program code itself and the storage medium storing it constitute the present disclosure. As the storage medium for supplying such program code, for example, a flexible disk, CD-ROM, DVD-ROM, hard disk, optical disk, magneto-optical disk, CD-R, magnetic tape, non-volatile memory card, ROM, etc. are used.

Further, based on instructions of the program code, an OS (Operating System) operating on the computer or the like may perform a part or all of actual processing, and the functions of the above-described embodiment may be realized by the processing. Furthermore, after the program code read out from the storage medium is written into a memory on the computer, based on instructions of the program code, a CPU of the computer or the like may perform a part or all of actual processing, and the functions of the above-described embodiment may be realized by the processing.

Furthermore, by distributing program code of software realizing the functions of the embodiment and each example via a network, they may be stored in storage means such as a hard disk or a memory of a system or an apparatus or a storage medium such as a CD-RW or CD-R, and a computer (or CPU or MPU) of the system or the apparatus may read out and execute the program code stored in the storage means or the storage medium at the time of use.

The processes and technologies described herein are not inherently related to any specific apparatus, and may be implemented by a combination of respective components. Also, various types of general-purpose devices can be added. A dedicated apparatus may be constructed to execute the functions of the present embodiment and each example. Further, various functions can be formed by appropriately combining a plurality of constituent elements disclosed in the present embodiment and each example. For example, some constituent elements may be deleted from all constituent elements shown in the embodiment and each example, or constituent elements across different examples may be appropriately combined.

In the present disclosure, specific examples are described, but these are for explanation (understanding of the technology of the present disclosure) and not for limitation in all aspects. Those having ordinary knowledge in this technical field will understand that there are numerous combinations of hardware, software, and firmware suitable for implementing the technology of the present disclosure. For example, the described software can be implemented in a wide range of programs or script languages such as Assembler, C/C++, perl, Shell, PHP, Java (registered trademark), etc.

Furthermore, in the above-described embodiment, control lines and information lines indicate those considered necessary for explanation, and do not necessarily indicate all control lines and information lines on the product. All configurations may be interconnected.

In addition, those having ordinary knowledge in this technical field can clarify other implementations of the present disclosure based on consideration of the present embodiment and each example. The specification and specific examples are merely typical, and the scope and spirit of the technology of the present disclosure are shown in the following claims.

The invention is not limited to the foregoing embodiments, and various variations/changes are possible within the spirit of the invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

According to the technology of the present disclosure, even when a terminal apparatus cannot receive a Cell Switch command, handover processing can be executed, and speeding up of processing and shortening of instantaneous interruption time can be realized.

What is claimed is:

1. A terminal apparatus that communicates with a plurality of base station apparatuses while switching a connection destination, comprising:
a storage device that holds a program regarding handover; and
a processor that reads the program from the storage device and executes handover processing, wherein
the processor executes:
acquiring a communication parameter associated with at least one handover destination candidate base station apparatus and information on an LTM execution condition from a connected handover source base station apparatus;
determining whether the LTM execution condition associated with a handover destination candidate base station apparatus is satisfied before receiving a Cell Switch Command instructing a change of a connection destination cell from the handover source base station apparatus; and
transmitting an RA preamble to the handover destination candidate base station apparatus associated with the LTM execution condition when the LTM execution condition is satisfied.

2. The terminal apparatus according to claim 1, wherein the processor acquires information on a specific event including CondEventA3, CondEventA4, CondEventA5, CondEventD1, and CondEventT1 defined in a 3GPP standard as the LTM execution condition for each of the at least one handover destination candidate base station apparatus.

3. The terminal apparatus according to claim 1, wherein when detecting a radio link failure, the processor executes a determination that LTM is executable when satisfaction of the LTM execution condition cannot be confirmed and a predetermined wireless quality at which communication is possible is confirmed regarding a destination of cell switching by LTM execution.

4. The terminal apparatus according to claim 1, wherein when detecting a radio link failure, the processor executes reconnection starting from a cell search when a predetermined wireless quality at which communication is possible cannot be confirmed regarding a destination of cell switching by LTM execution.

5. The terminal apparatus according to claim 1, wherein the processor receives information for specifying a measurement target of wireless quality and a first identifier associated with the information, information specifying a timing of reporting to a base station apparatus and a second identifier associated with the information, information associating a wireless quality measurement target , a reporting target, and a reporting timing using the first identifier and the second identifier, and a third identifier associated with the information, and designates the LTM execution condition by the third identifier.

6. The terminal apparatus according to claim 5, wherein
the first identifier is measObjectId,
the second identifier is reportConfigId, and
the third identifier is MeasId.

7. The terminal apparatus according to claim 1, wherein the processor deletes a part or all of a first communication parameter and a first LTM execution condition of a first handover destination base station apparatus, and a second communication parameter and a second LTM execution condition of a second handover destination base station apparatus by an instruction from the handover source base station apparatus when cell switching succeeds after transmitting an RA preamble.

8. A wireless communication system comprising a plurality of base station apparatuses and at least one terminal apparatus, which executes a handover from a handover source base station apparatus to a handover destination candidate base station apparatus, wherein
the handover source base station apparatus to which the terminal apparatus is connected executes:
transmitting a communication parameter associated with at least one handover destination candidate base station apparatus and information on an LTM execution condition to the terminal apparatus; and
transmitting a Cell Switch Command instructing to change a connection destination to the handover destination candidate base station apparatus to the terminal apparatus, and
the terminal apparatus executes:
determining whether the LTM execution condition associated with a handover destination candidate base station apparatus is satisfied before receiving the Cell Switch Command from the handover source base station apparatus; and
transmitting an RA preamble to the handover destination candidate base station apparatus associated with the LTM execution condition when the LTM execution condition is satisfied.

9. The wireless communication system according to claim 8, wherein the terminal apparatus acquires information on a specific event including CondEventA3, CondEventA4, CondEventA5, CondEventD1, and CondEventT1 defined in a 3GPP standard as the LTM execution condition for each of the at least one handover destination candidate base station apparatus from the handover source base station apparatus.

10. The wireless communication system according to claim 8, wherein when detecting a radio link failure, the terminal apparatus executes determining that LTM is executable when satisfaction of the LTM execution condition cannot be confirmed, and a predetermined wireless quality at which communication is possible is confirmed regarding a destination of cell switching by LTM execution.

11. The wireless communication system according to claim 8, wherein when detecting a radio link failure, the terminal apparatus executes reconnection starting from a cell search when a predetermined wireless quality at which communication is possible cannot be confirmed regarding a destination of cell switching by LTM execution.
